(19) United States
(12) Patent Application Publication
(10) Pub. No.: US 2024/0060235 A1
(43) Pub. Date: Feb. 22, 2024

(54) METHOD OF PRINTING AN ACTIVE QR CODE ON AN ARTICLE OF CLOTHING AND ARTICLES OF CLOTHING HAVING AN ACTIVE QR CODE

(71) Applicant: Next-Level Sandbag LLC, East Jordan, MI (US)

(72) Inventor: John Charles Strehl, JR., East Jordan, MI (US)

(21) Appl. No.: 18/451,314

(22) Filed: Aug. 17, 2023

Related U.S. Application Data
(60) Provisional application No. 63/398,638, filed on Aug. 17, 2022.

(51) Int. Cl. D06P 5/00; G06K 19/06; G06K 1/12

(52) U.S. Cl. CPC D06P 5/00; G06K 19/06037; G06K 1/121

(57) ABSTRACT

A method of printing an active QR code on an article of clothing, the method including: creating an image of the active QR code to be printed, the image including an active QR code portion and a perimeter border surrounding the active QR code portion; and printing the image on the article of clothing.

### CROSS-REFERENCE TO RELATED APPLICATION

This application claims priority to and the benefit under 35 U.S.C. § 119(e) of U.S. Provisional Patent Application No. 63/398,638, filed on Aug. 17, 2022, entitled “METHOD OF PRINTING AN ACTIVE QR CODE ON AN ARTICLE OF CLOTHING AND ARTICLES OF CLOTHING HAVING AN ACTIVE QR CODE,” filed by J. Charles Strehl, II, the entire disclosure of which is hereby incorporated herein by reference.

### TECHNOLOGICAL FIELD

The present invention generally relates to a method of printing a quick response (QR) code, and more particularly, to a method of printing a QR code on an article of clothing.

### SUMMARY OF THE DISCLOSURE

In one aspect of the present disclosure, a method is provided for printing an active QR code on an article of clothing, the method including: creating an image of the active QR code to be printed, the image including an active QR code portion and a perimeter border surrounding the active QR code portion; and printing the image on the article of clothing.

In another aspect of the present disclosure, an article of clothing is provided comprising an active QR code printed thereon using a method including: creating an image of the active QR code to be printed, the image including an active QR code portion and a perimeter border surrounding the active QR code portion; and printing the image on the article of clothing.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a picture of a front side of an article of clothing having an active QR code;

FIG. 2 is a picture of a rear side of the article of clothing shown in FIG. 1;

FIG. 3 is an example of an active QR code that may be printed on the article of clothing shown in FIGS. 1 and 2; and

FIG. 4 is a flowchart illustrating the steps of the novel method of printing an active QR code on an article of clothing.

### DETAILED DESCRIPTION

The present illustrated embodiments reside primarily in combinations of method steps related to printing an active QR code on an article of clothing. Accordingly, the method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

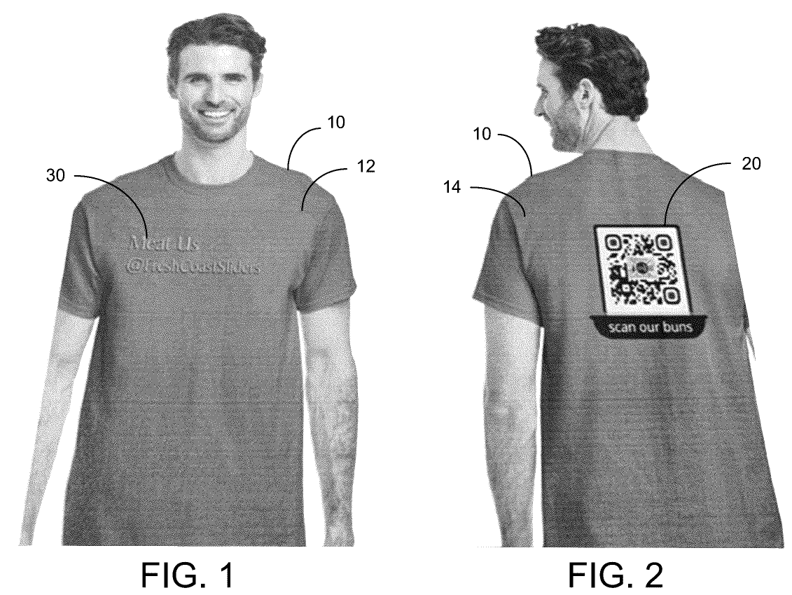

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the side of the article of clothing viewable from the front of the person wearing the article of clothing (FIG. 1), and the term “rear” shall refer to the side of the article viewable from the rear of the person wearing the article of clothing (FIG. 2). However, it is to be understood that the invention may assume various alternative orientations, except where expressly specified to the contrary. It is also to be understood that the specific clothing and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1 and 2, the reference numeral 10 generally designates an article of clothing such as a T-shirt, having a front side 12 (FIG. 1) and a rear side 14 (FIG. 2) on which an active QR code 20 is printed. The front side 12 may optionally include graphics or text 30 and preferably includes instructions to scan the active QR code 20 on the rear side 14 of the article of clothing 10.

As used herein, the term “active QR code” means a QR code that may be scanned using a smartphone or similar device and to provide data to the smartphone once scanned. Graphics that appear to show a QR code that cannot be scanned and are merely decorative are not considered active QR codes. The active QR code 20 may be a static QR code that provides static data to the smartphone or may be a dynamic QR code that provides a URL link to a website where dynamic data may be provided to the smartphone.

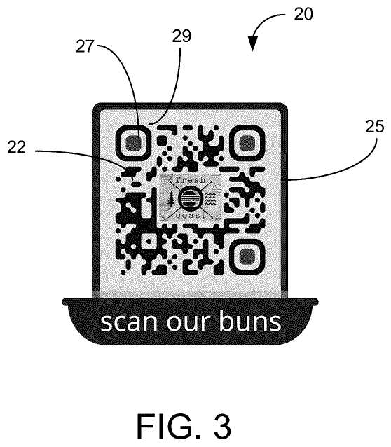

Through experimentation, the inventor found that merely printing a standard QR code generated using available QR code generators, on the back of a T-shirt, did not result in a QR code that can reliably be read more than three feet away when the T-shirt is worn. In fact, such standard QR codes had a fail-to-read rate of greater than 90% at three feet when the T-shirt is worn. However, by modifying the printed image of the active QR code 20 to include a perimeter border 25 surrounding the active QR code portion 22 as shown in FIG. 3, the resulting active QR code 20 could be reliably and consistently read at greater than three feet and up to 20 feet when the T-shirt is worn. Depending on the lighting and the make and model of smartphone used to scan the active QR code 20, the active QR code 20 could be scanned from upwards of 25 feet away. Thus, the inventive method improves the consistency, reliability, and distance at which QR codes can be read when printed on articles of clothing.

Uses for such articles of clothing having such printed active QR codes, include: providing links to menus on clothing worn by servers in a restaurant, providing links to a Go Fund Me™ website for a charity event, providing a link through which a person may pay a tip to a server wearing the active QR code, providing a connection to a wireless network, tracking where the QR code was scanned, displaying multimedia content (such as video audio, images, documents, etc.), providing a link to loyalty programs, and to implement any other known uses of active QR codes on articles of clothing.

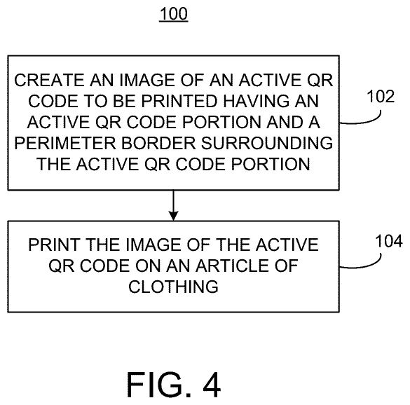

Having described an article of clothing 10 having an active QR code 20, a method of printing 100 the active QR code 20 on an article of clothing 10 will now be described with reference to FIG. 4. The method 100 includes creating an image of the active QR code 20 to be printed (step 102), where the image includes the active QR code portion 22 and a perimeter border 25 surrounding the active QR code portion 22. This step 102 may be performed by first inputting data or a URL link to any known QR code generator, and then modifying the image to include a perimeter border 25 surrounding the generated image of the active QR code portion 22. Then, the modified image is printed on the article of clothing 10 to provide the active QR code 20 (step 104).

Although step 102 is described above as first forming the image of the active QR code portion 22 using a conventional QR code generator and then modifying the image to include the perimeter border 25, these steps could be implemented in one step using a novel QR code generator that automatically creates the image with the perimeter border 25.

The perimeter border 25 is preferably about 3/16 to ½ inch wide. Such a border 25 is particularly effective for QR codes that are 8 inches by 8 inches, to allow for consistent and accurate scanning from up to 20 feet away. With a border of about ½ inch, an 8×8 inch active QR code may be reliably read by the most different platforms of smartphones (i.e., Apple®, Android®, etc.).

Referring back to FIG. 3, the active QR code portion 22 includes one or more eyeballs 27 (or position markers) that each are surrounded by eyeframes 29 located at one or three of the corners of the QR code portion 22. These eyeballs 27 are used as positioning markings and indicate which direction the QR code has been printed.

The QR code 20 may be printed in one or more colors. Different portions may be printed in different colors. For example, the eyeball(s) 27 may be printed to match the color of the article of clothing 10 while the eyeframe(s) 29 may be a dark color but do not have to match or parallel the clothing color.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, use of materials, colors, orientations, etc.) without materially departing from the novel teachings and advantages of the subject matter recited. For example, the length or width of the elements may be varied, the nature or number of adjustment positions provided between the elements may be varied. It should be noted that the elements may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A method of printing an active QR code on an article of clothing, the method comprising:
creating an image of the active QR code to be printed, the image including an active QR code portion and a perimeter border surrounding the active QR code portion; and
printing the image on the article of clothing.

2. The method of claim 1, wherein the border is at least 3/16 inch wide.

3. The method of claim 1, wherein the border is about ½ inch wide.

4. The method of claim 1, wherein the printed active QR code is readable using a smartphone from a distance of at least 3 feet away when the article of clothing is worn.

5. The method of claim 1, wherein the printed active QR code is readable using a smartphone from a distance of up to 20 feet away when the article of clothing is worn.

6. An article of clothing comprising an active QR code printed thereon using the method of claim 1.

7. The article of clothing of claim 6, further comprising instructions printed on an opposite side of the article of clothing than the active QR code, wherein the instructions instruct a person to scan the QR code.

8. An article of clothing comprising an active QR code printed thereon using a method including:
creating an image of the active QR code to be printed, the image including an active QR code portion and a perimeter border surrounding the active QR code portion; and
printing the image on the article of clothing.

9. An article of clothing comprising:
a fabric configured to function as the article of clothing; and
an active QR code printed on the fabric including an active QR code portion and a perimeter border surrounding the active QR code portion, wherein the border is at least 3/16 inch wide.

10. The article of clothing of claim 9, wherein the border is about ½ inch wide.

11. The article of clothing of claim 10, wherein the printed active QR code is readable using a smartphone from a distance of at least 3 feet away when the article of clothing is worn.

12. The article of clothing of claim 10, wherein the printed active QR code is readable using a smartphone from a distance of up to 20 feet away when the article of clothing is worn.

13. The article of clothing of claim 9, wherein the printed active QR code is readable using a smartphone from a distance of at least 3 feet away when the article of clothing is worn.

14. The article of clothing of claim 9, wherein the printed active QR code is readable using a smartphone from a distance of up to 20 feet away when the article of clothing is worn.

15. The article of clothing of claim 9, further comprising instructions printed on an opposite side of the article of clothing than the active QR code, wherein the instructions instruct a person to scan the QR code.

16. The article of clothing of claim 10, further comprising instructions printed on an opposite side of the article of clothing than the active QR code, wherein the instructions instruct a person to scan the QR code.
